(19) United States
(12) Patent Application Publication
(10) Pub. No.: US 2013/0210624 A1
(43) Pub. Date: Aug. 15, 2013

(54) COMPOSITION FOR IMPROVING PLANT HEALTH AND METHOD OF APPLYING SAME

(71) Applicants: William J. Stringfellow, Linwood, KS (US); Jeffrey D. Hunter, Sarasota, FL (US); Allan K. Yust, Fishers, IN (US); Robert C. Adair, JR., Vero Beach, FL (US)

(72) Inventors: William J. Stringfellow, Linwood, KS (US); Jeffrey D. Hunter, Sarasota, FL (US); Allan K. Yust, Fishers, IN (US); Robert C. Adair, JR., Vero Beach, FL (US)

(21) Appl. No.: 13/369,741

(22) Filed: Feb. 9, 2012

(51) Int. Cl. C05G 3/02; A01P 21/00; A01N 59/26; A01P 3/00; C05B 9/00; A01N 25/12

(52) U.S. Cl. 504/101; 71/48; 504/367; 424/601

(57) ABSTRACT

A granular material employed as a fungicide or a fertilizer or both, comprising phosphorous acid (H₃PO₃) or phosphite (which may include HPO₃), along with a metal and phosphate on a granular carrier; or a mixture of a phosphite product and a phosphate product on a granular carrier; or mixture of a metal phosphite product and phosphate on a granular carrier. The mixture may contain a chelated metal on a granular carrier. Another mixture includes a phosphite product on a first granular carrier, and a phosphate product on a second granular carrier wherein the two are mixed and the phosphite product and the phosphate product may or may not include a metal ion. Alternatively the mixture may also contain a chelated metal on a third granular carrier. The compositions herein are preferably equipped with a time release mechanism.

### THE FIELD OF INVENTION

The present invention relates to a composition for and method of application of the composition for improving plant health, controlling fungal infection, and providing plant nutrients, specifically, phosphorous in a form bioavailable to plants. Further, the invention provides a means to control the release of the composition to provide longer lasting effects.

### BACKGROUND OF INVENTION

The element phosphorous is not found in nature in an uncombined state because it is so highly reactive with elements like hydrogen and oxygen. It does, however, appear in numerous general forms, including phosphonate (PO₃) and phosphate (PO₄). The term “phosphonate,” sometimes also referred to as “phosphite,” means the salts (organic or inorganic) of either phosphonic acid or phosphorous acid. The term “phosphate” means the salts (organic or inorganic) of phosphoric acid and includes polyphosphate, poly phosphite, polypyrophosphate, poly pyrophosphate, urea poly pyrophosphate, mono and diapotassium phosphate, mono potassium phosphate and any combination thereof.

In recent times, the role of phosphite relative to plant health was generally thought limited to fungicide applications. Demonstrated examples include Pythium, Rhizoctonia, fire blight, phelom and zylem inhabiting cankers etc. It is believed that a phosphate compound would demonstrate efficacy related to other pathogenic fungi, as well.

More recently, phosphite is understood to promote increased plant health and metabolic functioning, and stimulate a plant's natural defense mechanisms. Specifically phosphite has been documented to upregulate metabolic processes related to pathogen infection or the onset of adverse environmental conditions such as drought, heat, or salinity. Although it is absorbed by the plant's roots and leaves, it has been thought that the plants are incapable of directly using the phosphorous acid phosphite as a nutrient source. (McDonald, A. E., et al. 2001 J. Plant Nutr. 24(10); 1505-1519; Lanschoot, P. and Cook, J. (2005) Golf Course Management November (73077); Guest, D. I. (1985) Acta Horticulturae (166)63-64; Fenn, M. E., and Coffey, M. D. (1884) 74(5): 606-611.

Alternatively, Research from Lovatt (1990) Better Crops/Vol. 90, (2006, No. 4) report phosphite supplied at a concentration equivalent to phosphate, is a poor source of plant nutrient, at least initially. Plants provided only phosphite sources of phosphorous performed more poorly than those receiving phosphate. However, when crops are replanted in the previously phosphite-fertilized soil, their performance is similar to crops grown in phosphate-fertilized soil. Phosphite used at recommended rates supply only 2 lb P₂O₅ at each soil application, which may be far below crop removal rates. Lovett's research reported that foliar application of phosphite can replace phosphate in citrus and avocado crops suffering from phosphorous deficiency provided application is timed to match the needs of the crop to avoid toxicity. Phosphite is more readily absorbed into plant tissues than phosphate. Specifically, a single prebloom foliar application of phosphite to oranges increased flower number and, thereafter, increased yield. Albrigo, L. C. (1999) Proc. Fla. State Hor. Soc. 112:1-4. This research suggests that phosphite offers more than just fungicidal activity. Therefore, the role of phosphite is not completely understood other than to understand that the timing of application of phosphite is important; without appropriate timing, plants may be stunted or suffer other toxic effects.

The role of phosphate has long been known and appears to be far less complex. Phosphorus in phosphate is taken up by plants as a fertilizer to provide phosphorous to the plants as part of the crucial nutrient trifecta of potassium, phosphorous and nitrogen.

The variance in uptake time by plants of phosphites vs. phosphates applied to soil or foliage and what appear to be synergistic effects of the two forms of phosphorous, has prompted at least one fertilizer to be marketed as an aqueous solution that contains both. This fertilizer is “Lexx-a-phos”. However, Lexx-a-phos is limited to dipotassium phosphite and dipotassium phosphate in aqueous solution.

It is also old in the art to deliver micronutrients, specifically metal ions, to plants. One means of such delivery is in the form of a chelated complex.

What was needed was a composition of phosphate and phosphite delivered in dry form, and, preferably, one that retards the dissolution of the phosphite in the soil.

The use of granular carriers for delivery of herbicides and pesticides is not necessarily new. Nor is the idea of creating granules that incorporate the herbicide or pesticide within the granule. However, the technology has improved over time and the number of alternative carriers has increased. Further, granular carriers may be coated with active ingredients, specific layer depths gauged to proportionally deliver different components and may include layers with selective solubility for effecting time release and/or moisture triggered release of active ingredients present in layers below.

Without intent to limit the invention in any way, applicants report certain observances when using a granular application. It has been observed by the applicants that employing PO₃ and PO₄ on granules provides a synergistic effect. When the PO3 is released from the granules into the soil and is taken up by the plant, a significant increase in root mass, root development, and root weight is observed in comparison to an equal rate of a liquid drench application. Further, better rooting is observed using the granule or dry application than the rooting observed for a foliar application at an equal rates.

Although it is not yet certain, applicants hypothesize that these effects may be related to a PO₄XPO₃ interaction in the soil around the root hairs in a symbiotic relationship. The plant may be picking up the PO₄ and utilizing it to maintain phosphorus levels within the plant demand while the PO₃ stimulates the ADP and ATP. In this way the PO₃ is not employed by the plant as a true nutrient food source for the plant but, it is theorized, is acting more like a true fungicide.

### SUMMARY OF INVENTION

It is an object of the present invention to provide a fertilizer containing phosphite or a fertilizer/fungicide composition;

It is another object of the present invention to provide a fertilizer and/or fungicide composition comprising phosphate and phosphite;

It is yet an additional object of the invention to improve over prior art by providing a composition to be delivered in dry form;

It is an object of the invention to provide the composition in a form having means to control the release of at least one of the components.

It is yet another object of the invention to improve over prior art by providing a composition, delivered in dry form, wherein the composition comprises phosphate, phosphorous and or chelated metal ions all for improvement of plant health.

It is an object of the present invention to provide a composition comprising phosphite and a growth promoting material or a biological such as an auxin or seaweed alginate for improvement of plant health.

The composition of the present invention is comprised of phosphate (PO₄) constituents or phosphonate (also known as phosphite) (PO₃) and phosphate constituents which, when combined, provide for a synergistic effect. For purposes of this application, the term phosphate includes polyphosphate, poly phosphite, poly pyrophosphate, poly pyrophosphite, urea poly pyrophosphate, mono and diapotassium phosphate, mono potassium phosphate and any combination thereof and some or all of which may be transient forms.

Further, it should be noted for clarity that phosphorous acid (its salt is a phosphite) and phosphonic acid (aka phosphonate) have the same molecular formula yet are structurally different. They exist in equilibrium with each other. In terms of plant usage, phosphorous acid and phosphonic acid are one and the same. Over time, phosphorous acid will oxidize to phosphate.

The synergistic effect resulting from the combination of phosphate and phosphite results in increased protection against infection by Phytophthora without detriment to the plant that may otherwise be caused by the application of phosphite. It is theorized that the composition of the present invention increases metabolic responses of the plant, and the provision of phosphorous for nutrient purposes at the same time.

In one embodiment, the composition may include combining the phosphite with a metal cation, either physically or chemically. In another embodiment the metal cation is delivered in a chelating compound along with the phosphate. The composition may be applied via dry application to plants or, to roots via injection or broadcast application to the soil. More preferably, the composition is either dried to form a granular material or, most preferably, it is sprayed on to an agriculturally acceptable granular carrier. One embodiment of the composition will contain an effective amount of a phosphite and a phosphate, or a phosphite combined with a metal cation and a phosphate, or a phosphite and phosphate combined with a metal ion or chelated metal ions, or some other permutation of the combination of phosphite, phosphate and metal cation or of only phosphite with or without a metal ion.

Another embodiment may include a biological compound in combination with the phosphite or with the phosphite and phosphate, or with the phosphite and metal or with a combination of phosphite and phosphate and metal in any of the forms disclosed herein.

For embodiments sprayed on to an agriculturally acceptable carrier, it is preferred that the carrier be granular in nature and loaded to at least 10% by weight composition, and, preferably, up to about 90% by weight composition. Most preferably, the loaded granules are also provided means for slow release of the coated composition. Such means may include an additional layer or coating having a level of moisture resistance engineered to dissolve over time, or a number of additional layers which may or may not include other plant nutrients and which may or may not require additional time to dissolve and which may be in addition to a layer or layers for moisture resistance to achieve a time release effect. The granules may then be broadcast onto the soil near plants, or injected into the soil. For granules including an outside layer that will adhere to plant tissue, the granules may be broadcast onto the plants themselves. The present invention may include spraying a superheated phosphate with a reacted metal ion (such as H₃PO₃+Fe₂) or a standard reacted PO₃ product, thereafter using the chelated metal, in either case resulting in a combination on the clay granule.

Other carriers may also be employed. For example, a carrier that comprises a glue material might incorporate a composition of the present invention and might be sprayed onto another carrier.

The composition of the present invention may further comprise a growth promoting material which is combined with a phosphite product, with or without metal, or with the phosphite product, with or without metal. If a glue-like carrier is employed, the composition might be sprayed directly on seed for delivery with the seed into the furrow. Alternatively, this composition embodiment may be sprayed onto granules, either as separate components and/or layers, or as a mixture.

Other objects, features, and advantages of the present invention will be readily appreciated from the following description. The description makes reference to the accompanying drawings, which are provided for illustration of the preferred embodiment. However, such embodiment does not represent the full scope of the invention. The subject matter which the inventor does regard as his invention is particularly pointed out and distinctly claimed in the claims at the conclusion of this specification.

### BRIEF DESCRIPTION OF THE DRAWINGS

An example of the invention is described in detail below with reference to the attached drawing FIGURE, wherein:

FIG. 1 is an example process usable in a manufacture of various phosphate fertilizers.

### DETAILED DESCRIPTION OF THE PREFERRED EMBODIMENT

The preferred embodiment employs phosphite in one of many forms. Phosphites are the salts of phosphorous acid. They may be produced using a variety of raw materials. Among the possible raw materials are urea, ammonium, potassium, sodium, calcium, zinc, manganese, magnesium, iron, aluminum and combinations thereof. For example, sodium phosphite is made by reacting (neutralizing) phosphorous acid with sodium hydroxide. It can also be made via reaction of a phosphorous-containing sludge with a mixture of calcium hydroxide, sodium hydroxide and water. In this reaction it is believed that nine major reactions actually take place during mixing of these components and based on these reactions the main by-products developed consist of sodium phosphite, calcium phosphite, dual salt, hydrogen and phosphine. The main reaction parameters that affect the yield of sodium hypophosphite in this reaction involve the P:NaOH:Ca(OH)₂:H₂O ratio, the reaction mixture pH, the reaction temperature and the phosphorous composition of the sludge. The optimum reaction conditions require a 1:0.6:0.6:20 molar ratio of the four major reactants, a pH value that should not be allowed to drop lower than 11 and a temperature in the range of 85-95° C. The sludge employed as a raw material for the determination of these parameters should contain at least 50% phosphorous. For the sludge reaction, a pH value of less than 11 leads to intense formation of phosphates and decrease in sodium hypophosphite yield. INCO-CT-2005-013359 20 Feb. 2009 Page 4 of 30 ECOΦOS Publishable Final Activity Report ECOΦOS.

Phosphite may also be produced by combining phosphorous trichloride with ethanol at temperatures below 20 degrees Celsius, followed by dissolving metallic aluminum to produce aluminum chloride which, with water, results in diethyl phosphite. Diethyl phosphite may also be produced by a process comprising reacting triethyl phosphite with phosphorous acid in a reactor in a molar ratio of from about 2.05:1 to about 2.30.

Phosphorous containing fertilizers may be produced in a number of ways. For example, it has long been known that certain phosphorous-containing compositions act as fertilizer for plants. Rock phosphate is the raw material used in the manufacture of most commercial phosphate fertilizers on the market. In the past, ground rock phosphate itself has been used as a source of phosphorous for acid soils. However, due to low availability of phosphorous in this native material, high transportation costs, and small crop responses, very little rock phosphate is currently used in agriculture.

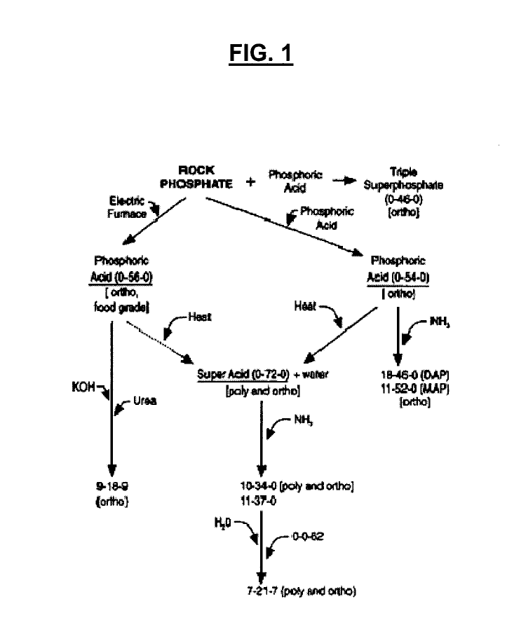

A process used in the manufacture of various phosphate fertilizers is as shown in FIG. 1

The manufacture of most commercial phosphate fertilizers starts with production of phosphoric acid. A generalized diagram showing the various steps used in the manufacture of various phosphate fertilizers is provided in FIG. 1. Phosphoric acid is produced by treating rock phosphate by an electric furnace to produce a very pure and more expensive phosphoric acid (frequently called white or furnace acid) used primarily in the food and chemical industry or by treating rock phosphate with acid producing phosphoric acid (also called green or black acid) and gypsum which is removed as a by-product. Either treatment produces orthophosphoric acid which is the phosphate form that is taken up by plants.

The phosphoric acid produced by treating rock phosphate with acid is frequently heated, driving off water and producing a superphosphoric acid. The phosphate concentration in superphosphoric acid usually varies from 72 to 76%. The phosphorous in this acid is present as both orthophosphate and polyphosphate. Polyphosphates consist of a series of orthophosphates that have been chemically joined together. Upon contact with soils, polyphosphates revert back to orthophosphates and are highly bioavailable.

Alternatively, ammonia can be added to the superphosphoric acid to create liquid or dry materials containing both nitrogen and phosphorous. The liquid, 10-34-0, is the most common product and can be mixed with finely ground potash (0-0-62), water, and urea-ammonium nitrate solution (28-0-0) to form 7-21-7 and related grades. When ammonia is added to the phosphoric acid that has not been heated, monoammonium phosphate (11-52-0) or diammonium phosphate (18-46-0) is produced depending on the ratio of the mixture. Importantly, the processes used to convert rock phosphate to fertilizer have no effect on the availability of phosphorous to plants. From “Understanding Phosphorous Fertilizers—Phosphorous in the Agricultural Environment” by George Rehm, Michael Schmitt, John Lamb, Gyes Randall, and Lowell Busman, posted on the University of Minnesota Extension website.

Another method employs a wet process of phosphoric acid to form sodium phosphate. The processes for monosodium dihydrogen phosphate, disodium monohydrogen phosphate and trisodium phosphate are similar except for the ratio of phosphoric acid to soda ash at the reactor stage and the type, size and construction of the crystallizing and drying equipment. In general, the initial reaction includes producing sodium phosphate salts by an acid base reaction between phosphoric acid and sodium hydroxide or soda ash (sodium carbonate) in a reactor. Potassium hydroxide and sodium chlorate may also be added to this initial reaction mixture. The potassium hydroxide is added to stabilize the crystallization process that occurs later in the production process and the sodium chlorate is added as a bleach. The overall reactions are:

2H₃PO₄+3Na₂CO₃62Na₃PO₄+3H₂CO₃ a)

H₃PO₄+3NaOH6Na₃PO₄+3H₂O b)

Phosphoric acid used in the production of sodium phosphate is manufactured using the wet phosphoric acid process. The sodium carbonate used in the process may be manufactured through the crystallization/purification process of mined Trona. The sodium hydroxide may be purchased commercially.

The product that results from the initial reaction depends upon the sodium/phosphate ratio present in the reaction mixture. The product may be reported as trisodium phosphate (Na₃PO₄) or disodium monohydrogen phosphate (HNa₂PO₄) feed liquor or a mixture of monosodium dihydrogen phosphate (H₂NaPO₄) and disodium monohydrogen phosphate.

The reaction solution may be filtered to remove any precipitated solids. The filtrate contains a mixture of monosodium/disodium liquor which may then be used as the feed liquor for all three processes. The next steps in the sodium phosphate production process are determined by the desired final products. For example, Monosodium dihydrogen phosphate (H₂NaPO₄) may be obtained by adding phosphoric acid to the feed liquor to adjust the sodium/phosphate ratio, producing a monosodium dihydrogen phosphate solution.

Generally, any metal ion that can be reacted in the manufacturing process of PO₃. For example, one of skill in the art would know that phosphorous acid and zinc carbonate, zinc oxide or iron carbonate, iron oxide and all the other carbonate and oxide forms of the metal ions can be reacted with phosphorous acid and then, again reacted with a hydroxide. For example, potassium hydroxide, ammonia hydroxide, anhydrous ammonia, sodium hydroxide or other hydroxides are reacted with the product of the phosphorous acid and carbonate or oxide form of the metal ion to form a PO₃ metal ion containing product. In these scenarios, the amount of metal in the product varies by the reactive value of the ion. Typically, 5% to 10% metal by weight of the product is achieved and is stable in a liquid form. In one embodiment of the present invention the PO₃ metal ion containing product is then sprayed onto granules. In another embodiment of the present invention, the normal stable mole value is exceeded by working with a heated super saturated solution of the metal ion and PO₃. Superheating is used to keep metal ion/PO₃ product from precipitating out of solution and to achieve a far higher load of the reacted phosphorous and metal ion containing substance on the granule than would be expected via spray drying a solution that is not superheated. The heated super saturated solution may be hot-sprayed onto granules either alone, or with phosphate materials or other materials.

One embodiment of the present invention includes chelated metal ions. In this embodiment, the chelated metal ion is applied to granules, either the same granules as one of the phosphate or phosphite materials, or on to separate granules for mixing with granules bearing the phosphate or phosphite materials, or mixing with granules bearing phosphate and another metal ion, or phosphite and another metal ion, or mixing any combination of the above or other obvious combinations including one or more of the phosphate, phosphite, phosphate metal, phosphite metal, and chelated metal ions.

The chelated metal ions (like the metal when combined with the phosphite or phosphate) include a micronutrient to be delivered to the plant. Chelated metal ions may be chelated by any known method employing any of many known chelating agents. A list of example chelating agents includes Ethylenediamine tetra-acetic acid (EDTA), Pentetic acid or diethylene triamine pentaacetic acid (DPTA), ethylenediamine-N,N-bis(2-hydroxyphenylacetic acid) EDDHA, Citric acid, fulvic acid, humic acid, and sodium glucoheptenate. This list is not intended to be a list of limitation, but a list of example. There are other metal chelating agents that might also be employed.

Chelated metal may be applied to the granules via hot mix spray in a rolling blender or spray impregnator system, either alone or in combination with a reacted PO₃ product described above. As in the above examples, application of the chelated metal to granules may be alone, or in combination with a reacted phosphite product, a phosphate product, both together, or in layers or coatings of first one and then another. Employing a superheated solution in the spray drying results in higher loads of the chelated metal on the granules or higher loads of the phosphorous containing products and chelated metal ions together on the granules. It is expected that the objectives of this invention may be accomplished with any of these combinations and the specific combination may be chosen in relation to the specific condition of the plants to which the combination may be applied.

The composition containing a phosphite product, with or without metal, and with or without phosphate product may also comprise a biological material such as seaweed alginate or a plant hormone such as, but not limited to, an auxin. For example, such auxin may be IBA or NAA. It is thought that IBA (or indole-butyric acid) plays a role in auxin response in relationship to the principle auxin, indole-acetic acid (IAA). IBA is used widely in horticultural settings because of its efficacy at inducing secondary roots on cuttings, but the molecular mechanisms of IBA action are unknown. Synthetic auxins, like naphthalene acetic acid, of NAA, are used extensively to promote root formation on stem and leaf cuttings.

The composition containing a phosphite product, with or without metal, and with or without a phosphate product, may also comprise a growth promoting material. Often, this combination will be delivered in the furrow with the seed of the plant to be grown, or applied soon thereafter very near the seed locale. A growth promoting material of this nature may comprise a substance or mixture or combination of substances intended through physiological action for accelerating or retarding the rate of growth or maturation or otherwise altering the natural behavior of seeds or plants. Some of the most common growth promoting materials include auxins, gibberelins, cytokinins, Ethylene generators, IBA (Indole-3-butryic acid).

Granule technology has been around for awhile and is used to produce kitty litter and oil absorbents. The materials used to make granules dictate their behavior. For example, in one embodiment the granules used are clay granules. The clay may be one of several types. One example includes granules made from montmorillonite clay which is mined at about 30% moisture. The clay is crushed to a size of about two inch cubes or less, then crushed again to less than about one inch. Thereafter, the cubes are dried in a kiln to less that 0.5% moisture. Finally, the cubes are screened to select for sizes.

For use in the present invention, the applicants have found that granules sized between about 50 sgn and 200 sgn work best, but sizes outside that range would also suffice. The method of applying the phosphate and phosphite materials of choice employs a blender or roller but other standard methods of granule application may be equally useful. A given amount of phosphate material, phosphite material and clay granules are blended for a time adequate for the granules to absorb the materials within their porous structure. Due to the nearly dry state of the granules and their porous nature, the phosphate and phosphite materials are quickly and uniformly absorbed.

Other clays may be used to create granules for use in the present invention. However, the monmorillonite clay itself does not dissolve in aqueous conditions, whereas other granules which are wettable powders may be suspended in solution. The use of the montmorillonite granules is preferable and provides a method of uniform delivery of the composition of the invention.

Means for achieving release of the composition absorbed in the granule over time may optionally be provided. The granule onto which the composition has been absorbed may be coated with a number of different coatings, a single coat or layers. These layers may include additional amounts of the composition to provide its availability over a longer time frame, or may include other plant nutrients as desired. The coating may include some moisture resistance for survival of the composition through some amount of rain, such as those provided herein or other means for effecting timed release. In a preferred embodiment, uncoated granules and coated granules are mixed together so that some of the composition is more quickly available, and the availability of the composition on the coated granules is delayed. Of course, mixtures where more than one type of coating is employed may also offer advantages both as to time of delivery and as to amounts or types of additional fertilizers, herbicides or pesticides desired and that may be administered along with the composition of the invention. Alternatively, a granular mixture may be used where granules of several types i.e. with or without a time release layer, with or without a layer or layers containing additional fertilizers or herbicides or pesticides, etc., are mixed together.

It was surprisingly found that the montmorillonite granules may be loaded between a rate of 10% to 90% by weight. At its upper limit, this load rate is markedly higher than available on the market for fertilizer or fungicide granules today, and offers means to reduce the volume of granules necessary to deliver the composition and reduces shipping costs and production costs. The load may be accomplished in a number of ways, one such possibility including super-heated spray application.

Although there are several methods for coating granules, some work better than others. Some of the methods employ different granules per se. For example, a granule may include a mixture of elemental sulfur and swelling clay to form a matrix. Fertilizer applied to these granules is actually incorporated in the matrix. Alternatively, clay and a dispersant may be mixed with fertilizer, then fed to a granulator to create a fertilizer granule that deteriorates more slowly than if the granule is made only from fertilizer. A granular substrate may be manufactured using a composition of one or more mineral components combined with a more light weight additive or additives and a water soluble binder. This combination provides for retention of shape and size prior to application, and allows for breakdown and disintegration thereafter.

Another approach includes nearly any granule, upon which is layered encapsulated fertilizers with permeable and/or semi-permeable coatings. The coating may be laid over a granule bearing a fertilizer layer, the coating either permeable or semi-permeable may also be applied to retard dispersal over time. The coating may comprise a variety of materials including polymer film or a degradable amorphous alkene-sulphur polymer.

Clay-based granules such as that sold by Oil-Dry Corporation as Verge™ may be formulated to disintegrate at an extremely fast rate such as one minute, or to dissolve far more slowly into thousands of microparticles. Formed from thousands of inert particles, the granules break down and blend into the landscape without leaving detrimental waste. The granules may be obtained in relatively uniform size and shape to provide more even treatment. The granules are preferably dust free or nearly dust free.

Granules may be comprised of the fertilizer or fungicide itself, or may also comprise inert materials such as dried clay, calcium carbonate, brick, pumice, pyrophyllite, sulfur, kaolin, dolomite, plaster, wood flour, sugars, sodium chloride or sodium sulfate.

A glue-like carrier might also be employed. In this case, a fast-drying glue and the composition of or components of the composition of the present invention are mixed. Before the glue mixture dries, it is applied to seeds or, even, to a granular carrier.

In short, it should be understood that the present invention incorporates the many different approaches to effecting a timed-release of the phosphite products described herein and the phosphate products described herein, and the mixtures thereof, with metal ions incorporated or in a chelated form. The above descriptions are provided merely as examples of the variety of granules, coatings, and technology available that may be so employed.

Thus, the present invention has been described in an illustrative manner. It is to be understood that the terminology that has been used is intended to be in the nature of words of description rather than of limitation.

Many modifications and variations of the present invention are possible in light of the above teachings. For example, a superheated solution containing a phosphite and a phosphate product, each including a metal ion, may be sprayed simultaneously on porous or matrixed granules. Alternatively, one may be sprayed on granules, the other sprayed on different granules and the granules, thereafter, mixed according to a formula. Further examples include chelated metal ions sprayed on yet other granules and mixed therewith, or chelated metal ions mixed with a phosphite product described herein and then hot sprayed onto a granule. Granules containing or made from a phosphite product containing a metal ion may include coatings to effect a timed release. Therefore, within the scope of the appended claims, the present invention may be practiced otherwise than as specifically described.

What I claim is:

1. A composition employed to improve plant health comprising at least one or a mixture of chemicals selected from the group consisting of phosphate and phosphite wherein said composition is loaded onto granules.

2. The composition of claim 1 wherein said granules comprise at least one time-release layer.

3. The composition of claim 1 wherein said composition further comprises means to effect time-release of at least one of said chemicals.

4. The composition of claim 1 wherein said phosphite comprises a metal.

5. The composition of claim 1 wherein said phosphate comprises a metal.

6. The composition of claim 1 wherein said phosphate comprises a metal and said phosphite comprises a metal.

7. The composition of claim 1 wherein said granules comprise montmorillonite clay.

8. The composition of claim 1 wherein said composition is loaded to between about 10% and about 90% of the granule's weight.

9. The composition of claim 1 wherein said composition is loaded to between about 50% and about 90% of the granule's weight.

10. The composition of claim 1 wherein said composition is loaded to between about 70% and about 90% of the granule's weight.

11. A substantially granular composition for application to plants wherein said granules include a first group of granules comprising a phosphite product.

12. The granular composition according to claim 11 further comprising a second group of granules comprising a phosphate product to achieve a synergistic effect.

13. The composition of claim 12 wherein at least one of said phosphate product or said phosphite product comprises a metal ion.

14. The composition of claim 12 wherein at least one of said first group and said second group of granules comprises a coating of slow dissolution material to provide a time-released effect.

15. The composition of claim 14 wherein said coating comprises at least one or a mixture of several from the group consisting of fertilizers, herbicides and pesticides.

16. The granular composition of claim 12 wherein said first group of granules comprising a phosphite product will release said phosphite at a rate different than said second group of granules comprising a phosphate product will release said phosphate.

17. The composition of claim 12 wherein said phosphite product comprises a metal.

18. The composition of claim 17 wherein said metal is selected from the group consisting of alkali metals.

19. A granular composition comprising at least one plurality of granules wherein at least one said plurality of granules comprises a phosphite product.

20. The granular composition of claim 19 wherein at least some of said at least one of said plurality of granules further comprises a phosphate product.

21. The granular composition of claim 19 wherein at least some of said at least one of said plurality of granules further comprises a growth promoting material.

22. The granular composition of claim 19 wherein at least one plurality of granules comprises a plant auxin.

23. The granular composition of claim 22 wherein said at least one plurality of granules comprising a phosphite product further comprises a plant auxin.

24. The granular composition of claim 19 wherein each of said granules further comprises means for timed release of said phosphite product.

25. The granular composition of claim 19 wherein at least one plurality of granules comprises a chelated metal.

26. The granular composition of claim 12 further comprising a chelated metal.
